(19) United States
(12) Patent Application Publication
(10) Pub. No.: US 2023/0269709 A1
(43) Pub. Date: Aug. 24, 2023

(54) PHYSICAL UPLINK CONTROL CHANNEL RESOURCE INDICATION FOR DYNAMIC TIME DIVISION DUPLEX

(71) Applicant: QUALCOMM Incorporated, San Diego, CA (US)

(72) Inventors: Konstantinos DIMOU, New York, NY (US); Yan ZHOU, San Diego, CA (US); Peter GAAL, San Diego, CA (US); Yi HUANG, San Diego, CA (US); Tao LUO, San Diego, CA (US); Seyedkianoush HOSSEINI, San Diego, CA (US); Jing SUN, San Diego, CA (US); Xiaoxia ZHANG, San Diego, CA (US)

(21) Appl. No.: 18/020,495

(22) PCT Filed: Sep. 21, 2021
(86) PCT No.: PCT/US21/51346

§ 371 Date: Feb. 9, 2023

(30) Foreign Application Priority Data
Sep. 22, 2020 (GR) 20200100570

(51) Int. Cl. H04W 72/0446; H04L 1/1829; H04L 5/14; H04W 72/21

(52) U.S. Cl. CPC H04W 72/0446; H04L 1/1861; H04L 5/14; H04W 72/21

(57) ABSTRACT

Aspects relate to an uplink channel resource indication for dynamic time division duplex systems where a number of various slot formats may be utilized. A slot format indicator (ID) for a physical uplink control channel (PUCCH) may be mapped to a respective uplink channel resource identifier (ID). The mapping correlates the slot format ID with the uplink channel resource ID to thereby identify at least one particular sub-slot or symbol in a slot usable for uplink (UL) transmissions on the uplink channel.

### PRIORITY CLAIM

This application claims priority to and the benefit of foreign patent application no. 20200100570 filed in the Hellenic Industrial Property Organization (HIPO) on 22 Sep. 2020, the entire contents of which are incorporated herein by reference as if fully set forth below in its entirety and for all applicable purposes.

### TECHNICAL FIELD

The technology discussed below relates generally to wireless communication networks, and more particularly, to providing resource indication for a physical uplink control channel (PUCCH) for dynamic time division duplex (TDD) communication.

### BACKGROUND

Wireless communication between devices may be facilitated by various network configurations. In one configuration, a wireless network may enable wireless communication devices (e.g., user equipment (UEs)) to communicate with one another through signaling with a nearby base station or cell. In wireless communication networks, such as those specified under standards for 5G New Radio (NR), dynamic time division duplex (TDD) is utilized to improve the spectrum efficiency of such networks. Dynamic TDD provides flexible traffic adaptation by allowing the uplink (UL) or downlink (DL) transmission direction to be changed dynamically, such as according to instantaneous traffic load for example.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an aspect, a method for wireless communication at a network node in a wireless communication network is disclosed. The method includes determining at least one slot format indicator (ID) that correlates to at least one slot format configuration utilized by the wireless communication network. Further, the method includes mapping the at least one slot format ID to a respective uplink channel resource identifier (ID), wherein the mapping correlates the at least one slot format ID with the uplink channel resource ID to identify at least one particular sub-slot or symbol in a slot usable for uplink (UL) transmissions on an uplink channel.

In another aspect, a network node in a wireless communication system is disclosed having a wireless transceiver, a memory, and a processor communicatively coupled to the wireless transceiver and the memory. The processor and the memory are configured to determine at least one slot format indicator (ID) that correlates to at least one slot format configuration utilized by the wireless communication network. Additionally, the processor and memory are configured to map the at least one slot format ID to a respective uplink channel resource identifier (ID), wherein the mapping correlates the at least one slot format ID with the uplink channel resource ID to identify at least one particular sub-slot or symbol in a slot usable for uplink (UL) transmissions on an uplink channel.

According to another aspect, a method for wireless communication in a user equipment (UE) in a wireless communication network is disclosed. The method includes determining at least one particular sub-slot or symbol in a slot usable by the UE for uplink (UL) transmissions on an uplink (UL) channel based on an uplink channel resource identifier (ID), wherein the uplink channel resource ID correlates at least one slot format ID associated with a slot format configuration with the uplink channel resource ID. Additionally, the method includes transmitting an uplink (UL) signal on the determined at least one particular sub-slot or symbol in the UL channel.

In yet further aspects, a user equipment (UE) operable in a wireless communication system is disclosed having a wireless transceiver, a memory, and a processor communicatively coupled to the wireless transceiver and the memory. The processor and the memory are configured to determine at least one particular sub-slot or symbol in a slot usable by the UE for uplink (UL) transmissions on an uplink (UL) channel based on an uplink channel resource identifier (ID), wherein the uplink channel resource ID is correlated to at least one slot format ID associated with a slot format configuration with the uplink channel resource ID. Additionally, the processor and memory are configured to transmit an uplink signal on the determined at least one particular sub-slot or symbol in the UL channel.

These and other aspects will become more fully understood upon a review of the detailed description, which follows. Other aspects, features, and embodiments will become apparent to those of ordinary skill in the art, upon reviewing the following description of specific, exemplary embodiments of in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

FIG. 1 is an illustration of a wireless communication system according to some aspects.

FIG. 2 is a conceptual illustration of an example of a radio access network according to some aspects.

FIG. 3 is a diagram illustrating an example of a frame structure for use in a radio access network according to some aspects.

FIG. 4 is a block diagram illustrating an example of a wireless communication system supporting beamforming and/or multiple-input multiple-output (MIMO) communication according to some aspects.

FIG. 5 illustrates an example timeline of transmissions in a communication system and a slot format change according to some aspects.

FIG. 6A illustrates an example timeline of transmissions during an instance of a first slot format from the example of FIG. 5 according to some aspects.

FIG. 6B illustrates an example timeline of the transmissions during an instance of a second slot format from the example of FIG. 5 according to some aspects.

FIG. 7 illustrates an example timeline of transmissions in a communication system and a slot format change with determination of an UL transmission symbol according to some aspects.

FIG. 8 illustrates an example timeline of transmissions in a communication system and a slot format change with a plurality of SPS transmissions and determination of UL transmission symbols according to some aspects.

FIG. 9 is a block diagram illustrating an example of a hardware implementation for a radio access network (RAN) node or entity employing a processing system according to some aspects.

FIG. 10 is a flow chart of a method in a network node for mapping or correlating an UL resource ID to a slot format configuration ID according to some aspects.

FIG. 11 is a block diagram illustrating an example of a hardware implementation for a wireless communication device employing a processing system according to some aspects.

FIG. 12 is a flow chart of a method in a UE for applying a mapping or correlation of an UL resource ID to a slot format configuration ID according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz). FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Various aspects of the present disclosure relate to providing or determining an indication of channel resources, such as a physical uplink control channel (PUCCH), for dynamic time division duplex (TDD) wireless communication systems. In some aspects, a slot format indicator (ID) is determined that correlates to at least one slot format configuration utilized by a wireless communication network. The slot format ID is mapped to a respective uplink channel resource identifier (ID), wherein the mapping correlates the slot format ID with the uplink channel resource ID to identify at least one particular sub-slot or symbol in a slot usable for uplink (UL) transmissions on the uplink channel (e.g., PUCCH).

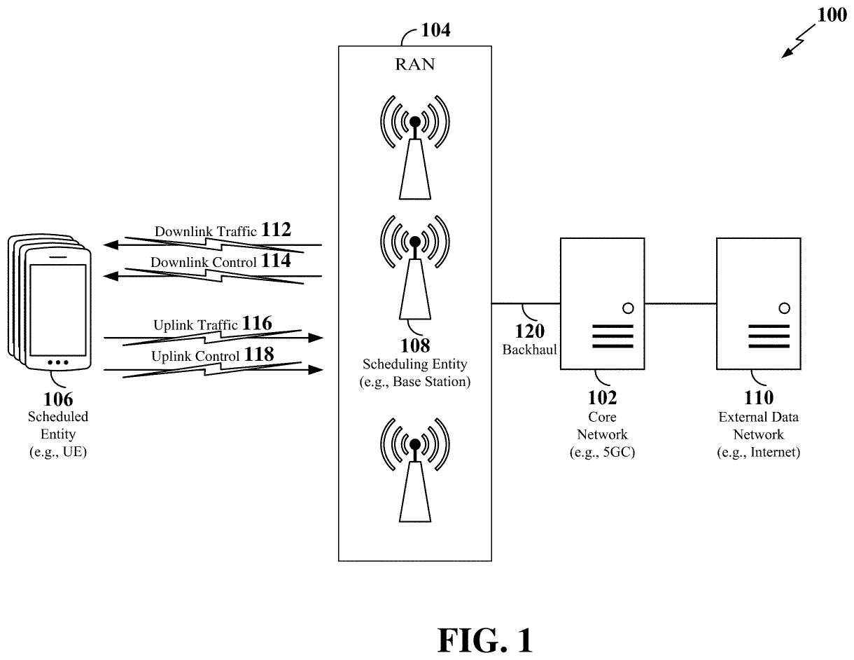

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and at least one scheduled entity 106. The at least one scheduled entity 106 may be referred to as a user equipment (UE) 106 in the discussion that follows. The RAN 104 includes at least one scheduling entity 108. The at least one scheduling entity 108 may be referred to as a base station (BS) 108 in the discussion that follows. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a network access node, a transmission and reception point (TRP) or some other suitable terminology. In some examples, a base station may include two or more TRPs that may be co-located or non-co-located. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, an industrial automation and enterprise device, a logistics controller, etc. Still further, a mobile apparatus may provide for connected medicine or telemedicine support. i.e., health care at a distance. Telehealth devices may include telehealth monitoring devices and telehealth administration devices, whose communication may be given preferential treatment or prioritized access over other types of information. e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). And as discussed more below, UEs may communicate directly with other UEs in peer-to-peer fashion and/or in relay configuration.

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

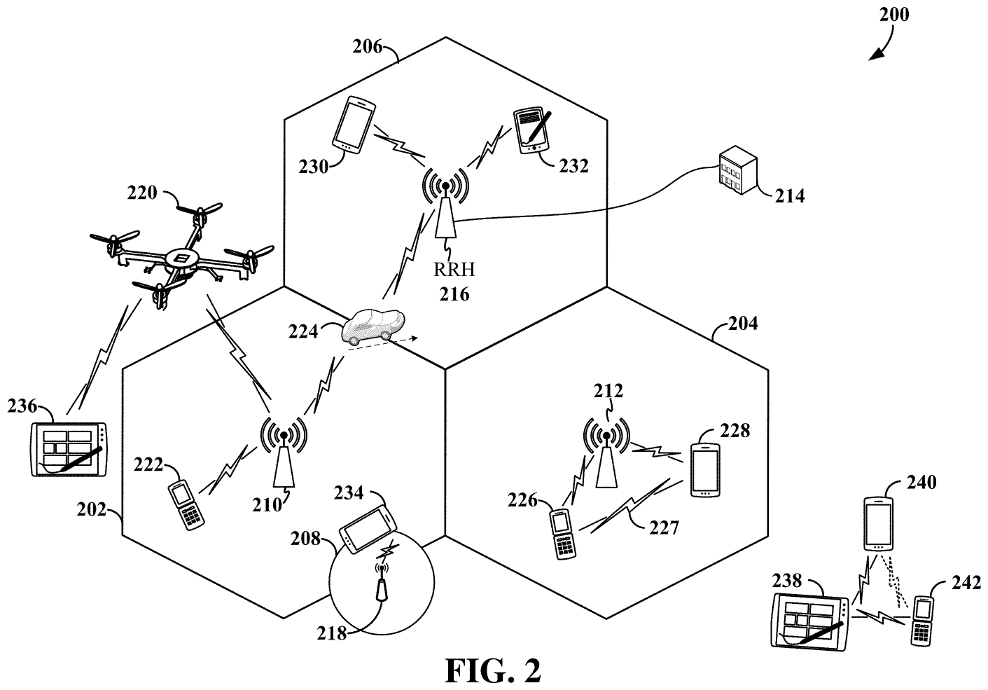

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 238, 240, and/or 242 may be the same as the UE/scheduled entity 106 described above and illustrated in FIG. 1.

In some examples, an unmanned aerial vehicle (UAV) 220, which may be a drone or quadcopter, can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may each function as a scheduled entity or a non-primary (e.g., secondary) sidelink device. In still another example, a UE may function as a scheduling entity or scheduled entity in a device-to-device (D2D), peer-to-peer (P2P), vehicle-to-vehicle (V2V) network, vehicle-to-everything (V2X) and/or in a mesh network. In a mesh network example, UEs 240 and 242 may optionally communicate directly with one another in addition to communicating with the UE 238 (functioning as a scheduling entity). Thus, in a wireless communication system with scheduled access to time-frequency resources and having a cellular configuration, a P2P configuration, or a mesh configuration, a scheduling entity and one or more scheduled entities may communicate utilizing the scheduled resources. In some examples, the sidelink signals 227 include sidelink traffic and sidelink control.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (cp). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes. The air interface in the radio access network 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequency implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), also known as flexible full-duplex.

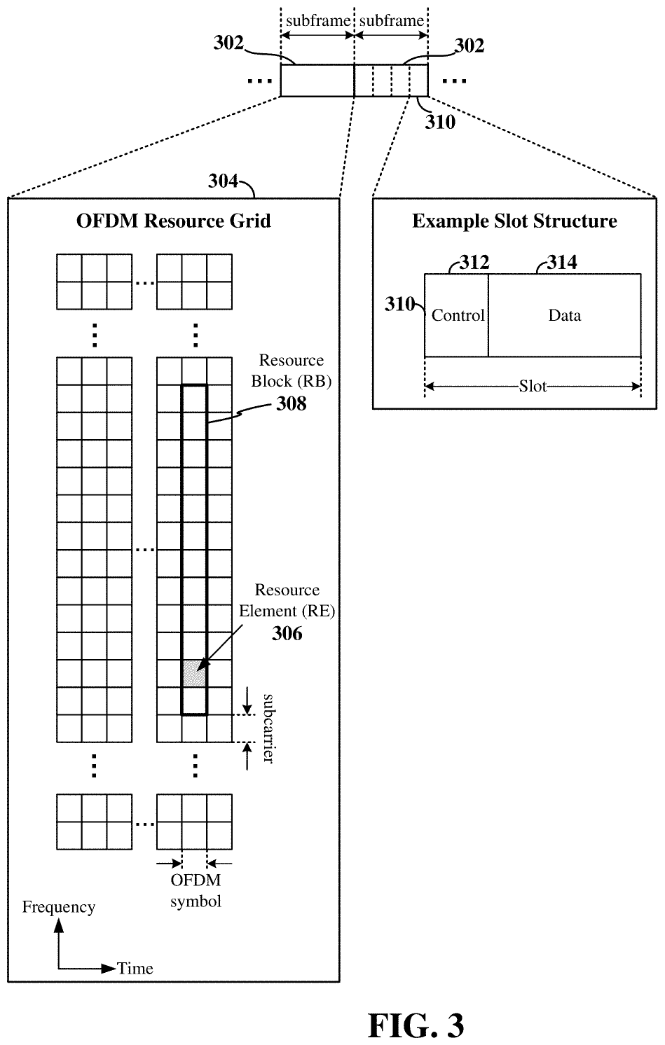

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example DL subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs (e.g., scheduled entities) for downlink or uplink transmissions typically involves scheduling one or more resource elements 306 within one or more sub-bands. Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals, including but not limited to a demodulation reference signal (DMRS), a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In a DL transmission, the transmitting device (e.g., the scheduling entity) may allocate one or more REs 306 (e.g., within a control region 312) to carry DL control information including one or more DL control channels, such as a PBCH and/or a physical downlink control channel (PDCCH), etc., to one or more scheduled entities. The PDCCH carries downlink control information (DCI) including but not limited to power control commands, scheduling information, a grant, and/or an assignment of REs for DL and UL transmissions. The transmitting device may further allocate one or more REs 306 to carry other DL signals, such as a DMRS; a phase-tracking reference signal (PT-RS); a channel state information—reference signal (CSI-RS); a primary synchronization signal (PSS); and a secondary synchronization signal (SSS). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The synchronization signals PSS and SSS, and in some examples, the PBCH and a PBCH DMRS, may be transmitted in a synchronization signal block (SSB) that includes 4 consecutive OFDM symbols, numbered via a time index in increasing order from 0 to 4. In the frequency domain, the SSB may extend over 240 contiguous subcarriers, with the subcarriers being numbered via a frequency index in increasing order from 0 to 249. Of course, the present disclosure is not limited to this specific SSB configuration. Other non-limiting examples may utilize greater or fewer than two synchronization signals; may include one or more supplemental channels in addition to the PBCH; may omit a PBCH; and/or may utilize a different number of symbols/frequencies and/or nonconsecutive symbols/frequencies for an SSB, within the scope of the present disclosure.

The PBCH may further include a master information block (MIB) that includes various system information, along with parameters for decoding a system information block (SIB). The SIB may be, for example, a SysteminformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESET0), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

As discussed above, a BS may transmit synchronization signals (e.g., including PSS and SSS) in the network to enable UEs to synchronize with the BS, as well as SI (e.g., including a MIB, RMSI, and OSI) to facilitate initial network access. The BS may transmit the PSS, the SSS, and/or the MIB via SSBs over PBCH and may broadcast the RMSI and/or the OSI over the PDSCH.

A UE attempting to access the network may perform an initial cell search by detecting a PSS from a BS (e.g., the PSS of a cell of the BS). The PSS may enable the UE to synchronize to period timing of the BS and may indicate a physical layer identity value assigned to the cell. The UE may also receive an SSS from the BS that enables the UE to synchronize on the radio frame level with the cell. The SSS may also provide a cell identity value, which the UE may combine with the physical layer identity value to identify the cell.

After receiving the PSS and SSS, the UE may receive system information from the BS. The system information may take the form of a master information block (MIB) and system information blocks (SIBs). The system information includes essential or critical information for a UE to access the network such as downlink (DL) channel configuration information, uplink (UL) channel configuration information, access class information, and cell barring information, as well as other less critical information. The MIB may include system information for initial network access and scheduling information for RMSI and/or OSI. After decoding the MIB, the UE may receive RMSI and/or OSI.

After obtaining the MIB, the RMSI and/or the OSI, the UE may perform a random access procedure for initial access to a RAN (e.g., the RAN 200 of FIG. 2). The RAN (e.g., a base station) broadcasts information that enables a UE to determine how to conduct the initial access. This information may include a configuration for a random access channel (RACH) that the UE uses to communicate with the RAN during initial access. The RACH configuration may indicate, for example, the resources allocated by the RAN for the RACH (e.g., resources allocated for transmitting RACH preambles and receiving random access responses).

For the random access procedure, the UE may transmit a random access preamble and the BS may respond with a random access response. Upon receiving the random access response, the UE may transmit a connection request to the BS and the BS may respond with a connection response (e.g., contention resolution message). After establishing a connection, the UE and the BS may enter a normal operation stage, where operational data may be exchanged. For example, the BS may schedule the UE for UL communication and/or DL communication.

In an UL transmission, the transmitting device (e.g., the scheduled entity 106) may utilize one or more REs 306 to carry UL control information including one or more UL control channels, such as a physical uplink control channel (PUCCH), to the scheduling entity. UL control information may include a variety of packet types and categories, including pilots, reference signals, and information configured to enable or assist in decoding uplink data transmissions. For example, the UL control information may include a DMRS or an SRS. In some examples, the control information may include a scheduling request (SR), i.e., request for the scheduling entity to schedule uplink transmissions. Here, in response to the SR transmitted on the control channel, the scheduling entity may transmit downlink control information that may schedule resources for uplink packet transmissions. UL control information may also include hybrid automatic repeat request (HARQ) feedback, channel state feedback (CSF), or any other suitable UL control information.

In addition to control information, one or more REs 306 (e.g., within the data region 314) may be allocated for user data traffic. Such traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry SIBs (e.g., SIB1), carrying information that may enable access to a given cell.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above in connection with FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

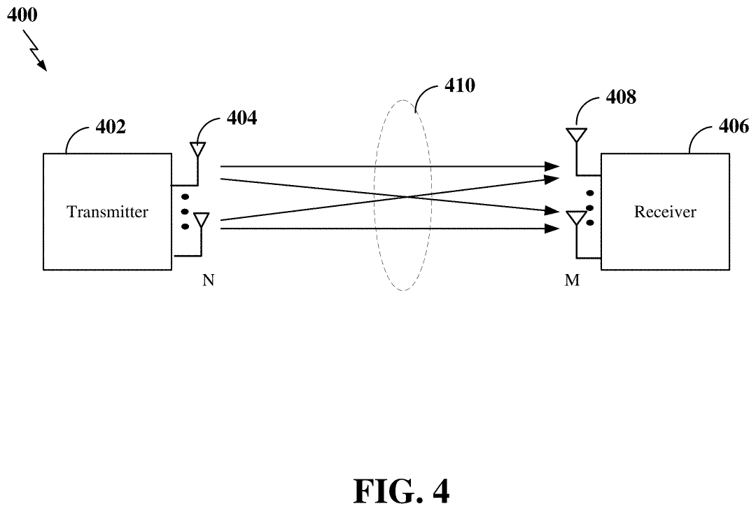

In some aspects of the disclosure, the scheduling entity and/or scheduled entity may be configured for beamforming and/or multiple-input multiple-output (MIMO) technology. FIG. 4 illustrates an example of a wireless communication system 400 supporting beamforming and/or MIMO. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. Each of the transmitter 402 and the receiver 406 may be implemented, for example, within a scheduling entity, a scheduled entity, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the wireless communication system 400 (MIMO system) is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In one example, as shown in FIG. 4, a rank-2 spatial multiplexing transmission on a 2×2 MIMO antenna configuration will transmit one data stream from each transmit antenna 404. Each data stream reaches each receive antenna 408 along a different signal path 410. The receiver 406 may then reconstruct the data streams using the received signals from each receive antenna 408.

Beamforming is a signal processing technique that may be used at the transmitter 402 or receiver 406 to shape or steer an antenna beam (e.g., a transmit beam or receive beam) along a spatial path between the transmitter 402 and the receiver 406. Beamforming may be achieved by combining the signals communicated via antennas 404 or 408 (e.g., antenna elements of an antenna array module) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406.

In 5G New Radio (NR) systems, particularly for systems operating above 6 GHz or mmWave systems, beamformed signals may be utilized for most downlink channels, including the physical downlink control channel (PDCCH) and physical downlink shared channel (PDSCH). In addition, broadcast control information, such as the SSB, slot format indicator (SFI), and paging information, may be transmitted in a beam-sweeping manner to enable all scheduled entities (UEs) in the coverage area of a transmission and reception point (TRP) (e.g., a gNB) to receive the broadcast control information. In addition, for UEs configured with beamforming antenna arrays, beamformed signals may also be utilized for uplink channels, including the physical uplink control channel (PUCCH) and physical uplink shared channel (PUSCH).

A base station (e.g., gNB) may generally be capable of communicating with UEs using transmit beams (e.g., downlink transmit beams) of varying beam widths. For example, a base station may be configured to utilize a wider beam when communicating with a UE that is in motion and a narrower beam when communicating with a UE that is stationary. The UE may further be configured to utilize one or more downlink receive beams to receive signals from the base station. In some examples, to select one or more downlink transmit beams and one or more downlink receive beams for communication with a UE, the base station may transmit a reference signal, such as an SSB or CSI-RS, on each of a plurality of downlink transmit beams in a beam-sweeping manner. The UE may measure the reference signal received power (RSRP) on each of the downlink transmit beams using one or more downlink receive beams on the UE and transmit a beam measurement report to the base station indicating the RSRP of each of the measured downlink transmit beams. The base station may then select one or more serving downlink beams (e.g., downlink transmit beams and downlink receive beams) for communication with the UE based on the beam measurement report. The resulting selected downlink transmit beam and downlink receive beam may form a downlink beam pair link. In other examples, when the channel is reciprocal, the base station may derive the particular downlink beam(s) to communicate with the UE based on uplink measurements of one or more uplink reference signals, such as sounding reference signals (SRSs).

Similarly, uplink beams (e.g., uplink transmit beam(s) at the UE and uplink receive beam(s) at the base station) may be selected by measuring the RSRP of received uplink reference signals (e.g., SRSs) or downlink reference signals (e.g., SSBs or CSI-RSs) during an uplink or downlink beam sweep. For example, the base station may determine the uplink beams either by uplink beam management via a SRS beam sweep with measurement at the base station or by downlink beam management via an SSB/CSI-RS beam sweep with measurement at the UE. The selected uplink beam may be indicated by a selected SRS resource (e.g., time-frequency resources utilized for the transmission of a SRS) when implementing uplink beam management or a selected SSB/CSI-RS resource when implementing downlink beam management. For example, the selected SSB/CSI-RS resource can have a spatial relation to the selected uplink transmit beam (e.g., the uplink transmit beam utilized for the PUCCH, SRS, and/or PUSCH). The resulting selected uplink transmit beam and uplink receive beam may form an uplink beam pair link.

Additionally, the systems illustrated in FIGS. 1, 2, and 4 may utilize dynamic TDD where the uplink (UL) and downlink (DL) transmission directions may be switched or formatted for respective various slots and, more particularly, for the various symbols within a slot. In particular, 5G NR specifies different slot formats where the number of UL, DL, and flexible (F) symbols are specified, as well as their positions in time within the slot (or slots). A symbol marked as flexible (F) means it can be used for either Uplink or Downlink as per requirement. In 3GPP TS 38.213, for example, a number of different slot formats from a range of format 0 to format 255 is specified. Each format has different combination of UL, DL, and flexible symbols. Practically, however, TS 38.213 only specifies 56 different slot formats even though up to 256 total may be possible.

In dynamic TDD scheduling, a UE may be scheduled with DCI in the PDCCH. Additionally, in systems utilizing semi-persistent scheduling (SPS), a UE may be provided with (1) a cell specific slot format configuration (e.g., tdd-UL-DL-ConfigurationCommon); (2) a dedicated slot format configuration (e.g., tdd-UL-DL-ConfigurationDedicated); or (3) a slot format through DCI. Further, the slot format can be configured through higher layer signaling either by tdd-UL-DL-ConfigurationCommon or tdd-UL-DL-ConfigurationDedicated signaling, as examples. According to TS 38.213, if a UE is additionally provided with the tdd-UL-DL-ConfigurationDedicated parameter, the parameter tdd-UL-DL-ConfigurationDedicated overrides only flexible symbols per slot over the number of slots as provided by tdd-UL-DL-ConfigurationCommon.

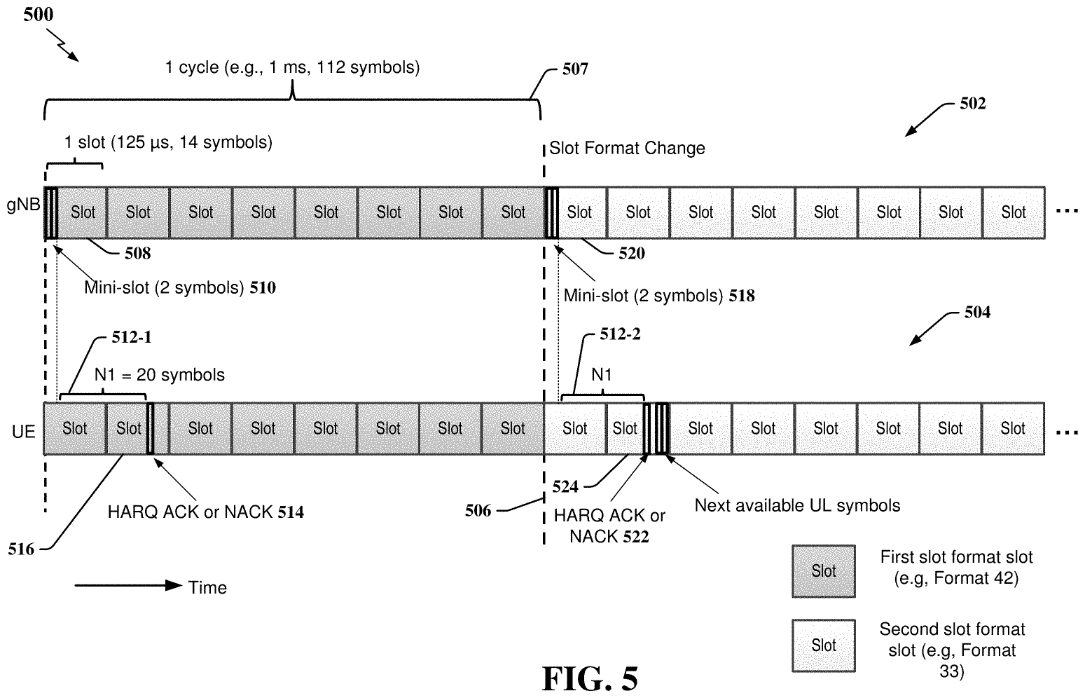

Turning to FIG. 5, this figure illustrates a timeline of transmissions in a dynamic TDD communication system with a semi-persistent scheduled (SPS) DL transmission such as a hybrid automatic repeat request (HARQ) transmission on a physical downlink shared channel (PDSCH), which is either acknowledged (ACK) or non-acknowledged (NACK) on the UL (e.g., on PUCCH). In this example, the use of slot format indication (SFI) for multiple slots is assumed. Accordingly, as illustrated the receive and transmit signaling for both a gNB and a UE (e.g., timelines 502 and 504, respectively) are illustrated in time where a first slot format is utilized prior to a time 506, at which time a slot format change is effected. After the time 506, a second slot format is used. As an example, the first slot format may be format 42 as defined by 3GPP 38.213 where in a slot of 14 symbols the first three symbols are DL symbols, the next three (3) symbols are flexible (F) symbols, and the remaining eight (8) symbols are UL symbols. The second slot format may be format 33 as defined by 3GPP 38.213, where the first nine (9) symbols are DL symbols, the next three (3) symbols are F symbols, and the remaining two (2) symbols are UL symbols.

The illustrated example of FIG. 5 also shows that a single cycle (e.g., 507) includes eight slots with each slot including 14 symbols for a total of 112 symbols in the cycle 507 for this example, such as is known in IoT applications where transmission is according to cycles and also employs semi-persistent scheduling (SPS). This numerology is same for both the first slot format and the second slot format in this example, but is not limited to such. Additionally, while the time of the cycle is show in FIG. 5 as 1 ms, this can be greater or less than this timing in other applications.

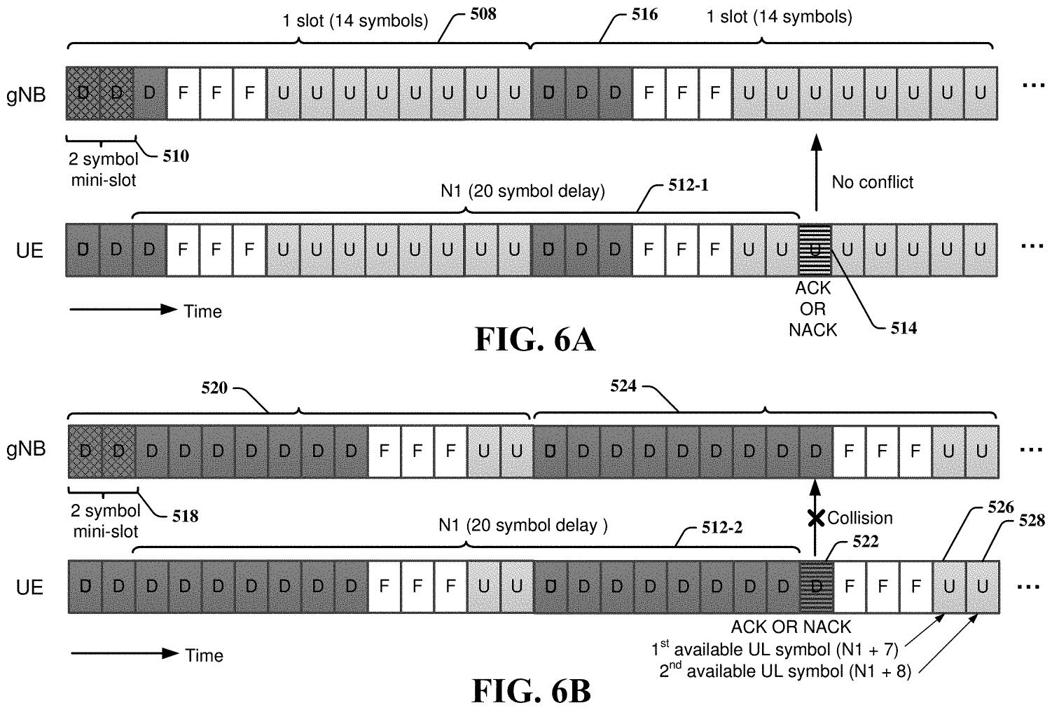

In timeline 502 showing the gNB transmit/receive signaling, DL signaling is shown in a slot 508 during the first slot format time, which may be a HARQ or some other SPS in some examples. The use of SPS signals may be beneficial in IoT applications requiring low latency and ultra-reliable links (e.g., Ultra-Reliable Low-Latency Communication (URLLC)). In the illustrated example, a mini-slot 510 of two symbols may be transmitted on the DL by the gNB. This transmission is further illustrated in FIG. 6A, which shows the time of the first two slots from the example of FIG. 5. As may be seen in FIG. 6A, these symbols in the mini-slot 510 are designated as DL symbols within the first slot 508 because of the particular slot format being used (e.g., Slot Format 42).

Turning back to FIG. 5, after the signaling (e.g., HARQ signaling) in the mini-slot 510 is transmitted on the DL, the UE will respond on the UL (e.g., PUCCH) with either an ACK or NACK after a processing delay time 512-1 (e.g., typically 20 symbols, but not limited to such, and which is equal to a value N1 in this example (or also “K1” duration of PDSCH-ACK/NACK Timing)) at a symbol 514 (e.g., the 23^{nd} symbol in mini-slot 510) that is transmitted on the UL in a next slot 516. Referring again to FIG. 6A, it may be seen that the symbol 514 is a designated UL symbol that will not conflict with transmissions by the gNB.

Referring again back to FIG. 5, after a slot format change at time 506, the gNB transmits a DL signal (e.g., HARQ or other SPS signal) in a mini-slot 518 within a first slot 520 after the format change. As may be seen in FIG. 6B, which illustrates the signaling during the first two slots after the slot format change, the two symbol mini-slot 518 is designated for DL transmissions for the gNB. Thus, the transmission of the DL signaling (e.g., HARQ or other SPS) does not present a potential for collision.

After the DL transmission in the mini-slot 518, the UE will respond to the transmission with feedback (e.g., ACK/NACK) after the N1 delay 512-2 as may be seen in both FIG. 5 and FIG. 6B. In the illustrated case, however, since the slot format has changed (e.g., changed to Format 33), a transmission of the feedback (ACK/NACK in symbol 522) after the N1 symbols 512-2 will occur when an DL symbol is scheduled under the slot format scheme as may be seen at symbol 522 in FIG. 6B. This may lead to a collision of the UL symbol 522 with DL signals. Additionally, the next available symbols for UL transmissions occur at symbols 526 and/or 528 as may be seen in FIG. 6B. It is noted that in this example, the first available UL symbol 526 will occur at N1+7 (i.e., the 27^{th} symbol in the mini-slot (i.e., slots 520+524)) and the second available UL symbol 528 will occur at N1+8 (i.e., the 28^{th} symbol in the mini-slot (i.e., slots 520+524)). In this collision scenario, however, it is not certain in which UL symbol (or even slot in the case when no further UL symbols are scheduled for UL in the present slot) the feedback (e.g., HARQ feedback) may be transmitted on the PUCCH, for example.

Accordingly, the present disclosure provides a mapping or correlation between a particular slot format (or slot format identifier (ID)) and a resource ID for the uplink channel (e.g., PUCCH). In this way, a UE (and/or gNB) may be configured such that when the UE receives the resource ID for the uplink channel, the UE is apprised of the particular slot format and also what UL resources may be used for transmission on the PUCCH, such as for transmission of an ACK/NACK in the case of an SPS HARQ as discussed above. This resource indication or ID allows the UE to dynamically accommodate for the dynamic TDD slot format changes in order to avoid collisions such as that discussed in connection with FIGS. 5 and 6 above.

In a particular example, a PUCCH resource indicator (also referred to herein as PUCCH Resource ID or PRI) is provided for or correlated to each slot format configuration, which may be designated or identified by a slot format ID by the network. This correlation allows the UE to select which UL symbol is available for transmitting feedback (e.g., ACK/NACK) on the PUCCH for the particular slot format configuration to avoid collision.

In a further example, the PUCCH Resource ID may be configured to include a PUCCH format with all of its particular parameters. For example, a PUCCH Resource ID may be configured as “n1PUCCH-AN” where AN denotes ACK/NACK. The resource ID n1PUCCH-AN may be configured with a PUCCH Resource ID parameter (e.g., PUCCH Resource ID 2) and a downlink data to uplink ACK (e.g., dlDataToUL-ACK) for a slot format (e.g., Slot Format 33). Further parameters include a starting physical resource block PRB (e.g., PRB #10), a flag or indication of whether intra-slot frequency hopping is enabled or not (e.g., intraSlotFrequencvHopping: ‘disabled’), the second hop PRB when there is frequency hopping (e.g., secondHopPRB: none, format 0), and a downlink to uplink ACK indication of a slot or sub-slot (e.g., DL-Data-To-ULACK=7th sub-slot (sub-slot of 2 symbols)). For a higher granularity, the DL-Data-To-ULACK (or PDSCH-to-HARQ_feedback) indication can be indicated per symbol; e.g. for a symbol of the 28 symbols in a sub-slot or mini-slot having two slots of 14 symbols.

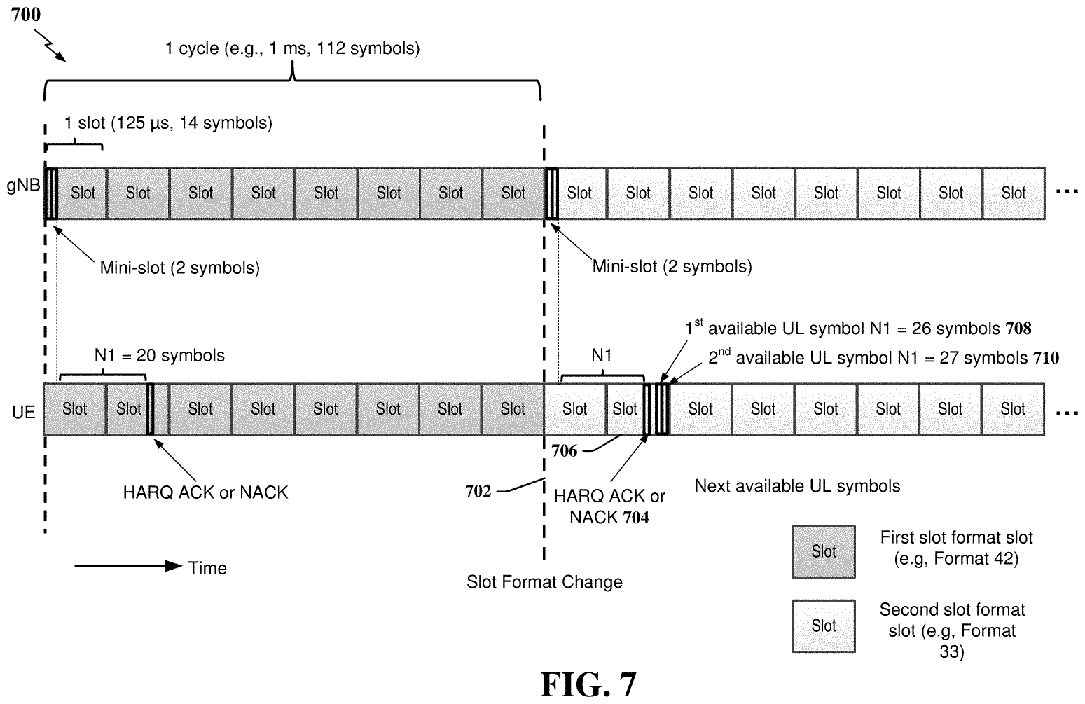

FIG. 7 illustrates a timeline similar to the example of FIGS. 5 and 6A, 6B where the system switches from a first slot format configuration (e.g., Slot Format 42) to a second slot format configuration (e.g., Slot Format 33) after time 702. Since the ACK/NACK symbol 704 will collide due to the slot format configuration change, either a 26^{th} or 27^{th} symbol in a sub-slot of two symbols (e.g., the 7^{th} two symbol sub-slot in the slot 704) which are shown at 706 and 708. In another example, the granularity may be configured to indicate the particular symbol (e.g., symbol 26 or symbol 27 which may correspond to symbols 526 and 528 in the example of FIG. 6B).

In another example of the configuration of the PUCCH Resource ID as mapped to another slot format configuration (e.g., Slot format 42), the resource ID may be an n1 PUCCH-AN=PUCCH Resource ID 3 & dlDataToUL-ACK for Slot Format 42 (e.g., starting PRB: #12, intraSlotFrequencyHopping: ‘enabled’, secondHopPRB: #36, format 2), DL-Data-To-UL ACK=3^{rd} sub-slot (i.e., a sub-slot being 2 symbols and the 3^{rd} sub-slot being symbols 5 and 6 in a slot).

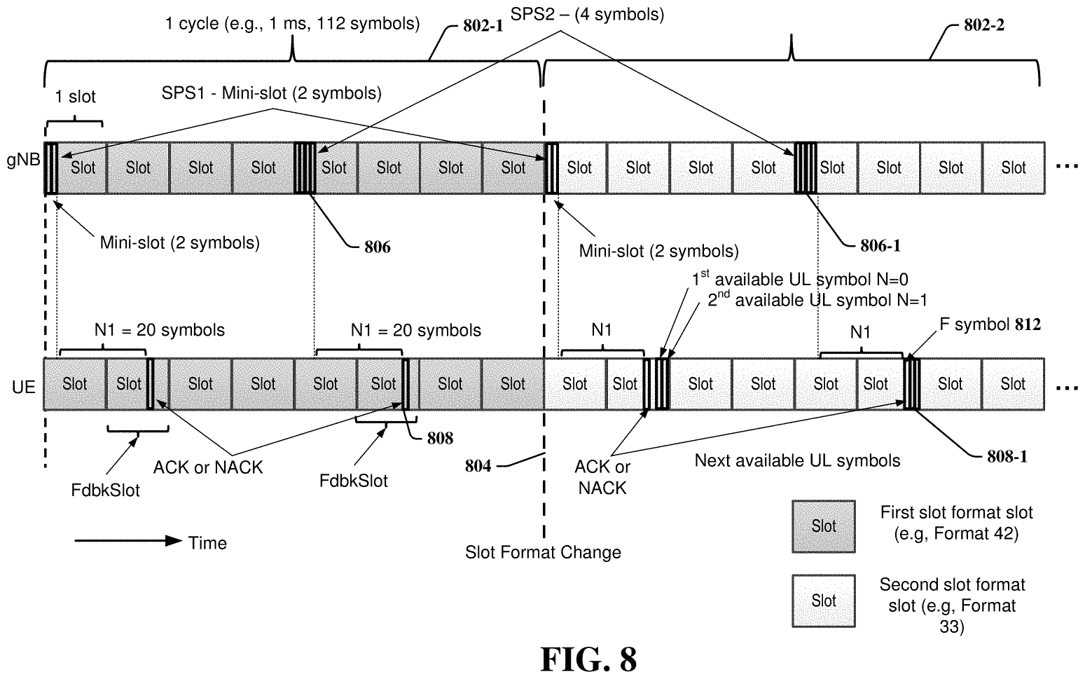

It is further noted that the presently disclosed concepts may be applied to multiple instances (i.e., two or more) of SPS transmissions within a cycle. FIG. 8 illustrates an example where two SPS transmissions (SPS1 and SPS2) are scheduled per cycle (e.g., cycle 802-1 or 802-2). Further, in this example, for a first slot format (e.g., format 43) before a slot format change time 804, in addition to the SPS1 DL transmission and UL ACK/NACK (which is the same as the examples of FIGS. 5-7), a 4-symbol DL transmission 806 (as merely an example and not limited to such) for SPS2 is shown in cycle 802-1. An ACK 808 transmitted is then on the UL by the UE as shown after the N1 processing time of the UE. In this case, the UL symbol used for ACK 808 will be an allocated UL symbol, so no collision will occur.

In the second slot format configuration after the change time 804, the transmission of the 4 symbol DL transmission 806-1 will be acknowledged through the UL transmission 808-1. In this instance, however, due to the second slot format configuration (e.g., Slot Format 33), the UL transmission will occur at a flexible F symbol 812. Accordingly, a next available UL symbol will be after F symbol 812.

In a particular example, the dlDataToUL-ACK (at RRC or PDSH-to-HARQ timing in L1) may be configured at the start of a UL OFDM symbol (or sub-slot) location for SPS PUCCH-AN Tx in the feedback slot (FdbkSlot), in which a UE's N1 processing time is located (and typically equal to K1). A value N may be configured as the index of UL symbol (or sub-slot) after symbol in which K1 (or N1) duration finishes. In one example, the value of N may be between 0 and 6 for a sub-slot that is equal to 2 symbols. Furthermore, a DL data to UL acknowledgment (Final dlDataToUL-ACK) configured at RRC or PDSH-to-HARQ timing in L1 may be configured as an initial dlDataToUL-ACK (at RRC or PDSH-to-HARQ timing in L1)+an N^{th} UL sub-slot (or UL symbol). Moreover, a final dlDataToUL-ACK (at RRC or PDSH-to-HARQ timing in L1) may be configured if a feedback slot configuration is known upon DL-Data-ToULAck(-r16) transmission.

In case an indicated UL symbol is not able to bear or carry the HARQ feedback, a first available UL sub-slot (or UL symbol) that can bear or carry the HARQ feedback, is used. For example, a PUCCH format 1 with 4 symbols as shown in FIG. 8 will be transmitted in the first slot configuration having four consecutive UL symbols available.

In some further examples, a gNB or network node may transmit an information element IE for the SPS-PUCCH-AN, an example of which is shown in TABLE 1 below.

TABLE 1
SPS-PUCCH-AN information element

| | |
|---|---|
| SPS-PUCCH-AN-r16 ::= | SEQUENCE { |
| sps-PUCCH-AN-ResourceID-r16 | PUCCH-ResourceId, |
| maxPayloadSize-r16 | INTEGER (4..256) |

OPTIONAL -- Need R

| | |
|---|---|
| Slot Format | Slot Format ID |
| (Normal Cyclic Prefix) | |

}

| | |
|---|---|
| PUCCH-ResourceSetId ::= | INTEGER |
| | (0..maxNrofPUCCH- |

ResourceSets−1)

| | |
|---|---|
| PUCCH-Resource ::= | SEQUENCE ( |
| pucch-ResourceId | PUCCH-ResourceId, |
| startingPRB | PRB-Id, |
| intraSlotFrequencyHopping | ENUMERATED |
| | { enabled } |

OPTIONAL, -- Need R

| | |
|---|---|
| secondHopPRB | PRB-Id |

OPTIONAL, -- Need R

| | |
|---|---|
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |

}
}

| | |
|---|---|
| DL-DataToUL-ACK-r16 ::= | SEQUENCE (SIZE |
| | (1..8)) OF |

INTEGER (−1..15)

| | |
|---|---|
| DL-DataToUL-ACK-r16 ::= | SEQUENCE (SIZE |
| | (1..32)) OF |

INTEGER (−1, 20 symbols (UE processing delay)..50 symbols)

The IE is communicated to a LE, and allows the UE to determine UL resources to be used for the PUCCH transmissions (e.g., ACK/NACK transmission).

In another example, it is noted that a dedicated grant (DO) may be utilized for effecting processes disclosed above for determining an UL symbol for the PDCCH. In an example, the PUCCH Resource (with a given PUCCH Resource ID) for the DG may be configured according to TABLE 2 below.

TABLE 2

| | |
|---|---|
| PUCCH-ResourceSetId ::= | INTEGER |

(0..maxNrofPUCCH-ResourceSets−1)

| | |
|---|---|
| PUCCH-Resource ::= | SEQUENCE { |
| pucch-ResourceId | PUCCH-ResourceId, |
| Slot Format (Normal Cyclic Prefix) | Slot Format ID |
| startingPRB | PRB-Id, |
| intraSlotFrequencyHopping | ENUMERATED { |

enabled }
OPTIONAL, -- Need R

| | |
|---|---|
| secondHopPRB | PRB-Id |

OPTIONAL, -- Need R

| | |
|---|---|
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |

}
}

| | |
|---|---|
| DL-DataToUL-ACK-r16 ::= | SEQUENCE (SIZE |

(1..8)) OF INTEGER (−1..15)

| | |
|---|---|
| DL-DataToUL-ACK-r16 ::= | SEQUENCE (SIZE |

(1..32)) OF INTEGER (−1, 20 symbols (UE processing
delay)..50 symbols)

In the example above, the DL_DataToUL-ACK-r16 contains either the exact feedback slot symbol location in which PUCCH HARQ feedback is to be transmitted or the location of the Feedback Slot available UL symbol, e.g. 1st, 2nd, or Nth UL Symbol.

The DL-DataToUL-ACK-r16 value can indicate the exact sub-slot (symbol) location, e.g., 14 sub-slots (sub-slot of 2 symbols) or 27 symbols such as was shown in the examples above, provided that the configuration of the feedback slot (i.e., ‘FdbkSlot’ in the illustrated examples) is the slot in which an initial N1 (or K1) period ends. The DL-DataToUL-ACK-r16 value can also indicate the order of the available UL sub-slot (or symbol) in the feedback slot, if the feedback slot configuration is not known.

In the case where DL-DataToUL-ACK-r16 does not indicate a valid UL sub-slot (or symbol) location, then a DCI format (e.g., DCI 2_0) containing a slot format indicator (SFI) may indicate the rule for UL symbol determination. Examples where the DL-DataToUL-ACK-r16 does not indicate a valid UL sub-slot may include when a 2nd UL sub-slot (or symbol) for PUCCH Format 1 with 4 UL symbols is needed (e.g., Slot Format #5). Another example where the DL-DataToUL-ACK-r16 does not indicate a valid UL sub-slot (or symbol) location may be when a 5th UL sub-slot (or symbol) for PUCCH Format 0 with 1 UL symbol is needed and Slot Format Indication does not contain 5 UL symbols, even including Flexible symbols (e.g., Slot Format #6).

Of further note, a DCI format 2_0 (containing SFI) indicating the rule for UL symbol determination may include an instance where all PUCCH AN fall in DL symbols to be transmitted at an Xth UL sub-slot (symbol)′ (e.g., flexible symbols are allocated either to UL or DL and hence there is no ambiguity with regard to the flexibility symbol(s)). In some other examples, a UL scheduler may be configured to keep track of “DL-DataToUL-ACK(-r16)” values and their updated values when the slot format configuration changes and to perform appropriate UL sub-slot (symbols) scheduling including taking into consideration other UL traffic.

As disclosed above, the dlDataToUL-ACK location per slot format configuration is specified or mapped. In some implementations, this mapping may be established for the 56 configurations defined in the 3GPP specifications. In another example, however, the dlDataToUL-ACK location may be configured for a subset or group of slot format configurations (e.g. for the slot format configurations having been used in the last 5 ms or to be used in the coming 5 ms, if future slot format configurations available). In yet another example, a generic timing may be utilized. For example, a second available UL sub-slot (symbol) may be used for a PUCCH format 0 or a PUCCH format 2 for slot configurations containing at least 2 UL symbols (e.g., slot formats 1, 9-15, 22-27, 31-42, 44-52, and 55 as specified in 3GPP TS 38.213). It is noted that the above examples may be applied to dedicated grant cases as well.

In yet another example, when the feedback slot (FdbkSlot) does not contain the correct or needed amount of UL symbols and the SFI rule discussed above is not applicable, then transmission at a first available UL sub-slot occasion with the correct or needed amount of UL symbols may be utilized. In another example, when the feedback slot (FdbkSlot) does not contain the correct or needed amount of UL symbols and the SFI rule is not applicable, then transmission at an Nth occasion with the available number of symbols may be utilized, where N is the number discussed in the examples above. Furthermore, it is noted that these examples may be provided a transmission instant before the packet expiration.

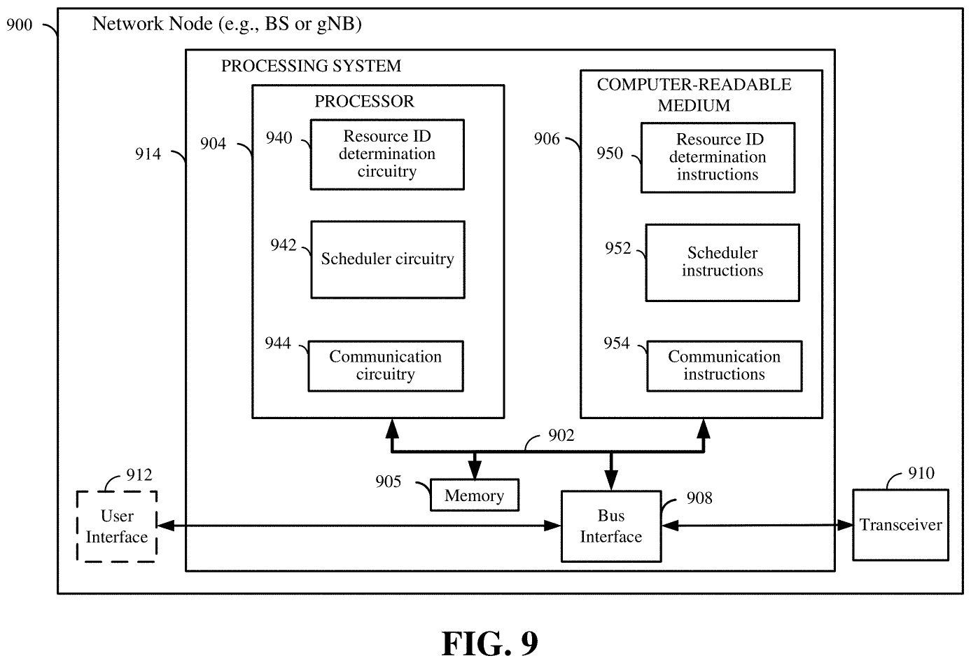

FIG. 9 is a block diagram illustrating an example of a hardware implementation for a network node (i.e., a RAN node 900) employing a processing system 914. For example, the network or RAN node 900 may be any of the base stations (e.g., gNB) illustrated in any one or more of FIG. 1, 2, or 4 discussed earlier.

The network node 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the Network node 900 may be configured to perform any one or more of the functions described herein. That is, the processor 904, as utilized in a Network node 900, may be used to implement any one or more of the processes described herein. The processor 904 may in some instances be implemented via a baseband or modem chip and in other implementations, the processor 904 may itself comprise a number of devices distinct and different from a baseband or modem chip (e.g., in such scenarios is may work in concert to achieve aspects discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), and computer-readable media (represented generally by the computer-readable storage medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium (e.g., air interface). A user interface 912 (e.g., keypad, touchpad, display, speaker, microphone, etc.) may also be provided.

The processor 904 is responsible for managing the bus 902 and general processing, including the execution of software stored on the computer-readable storage medium 906. The software, when executed by the processor 904, causes the processing system 914 to perform the various functions described herein for any particular apparatus. The computer-readable storage medium 906 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 906.

The computer-readable storage medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 906 may reside in the processing system 914, external to the processing system 914, or distributed across multiple entities including the processing system 914. The computer-readable storage medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include resource ID determination circuitry 940 that is configured to determine an UL resource channel ID (e.g., the n1PUCCH-AN, which include a PUCCH resource ID as discussed above and may further include the dlDatatoUL-ACK mapping) for each particular slot format configuration. In some examples, the resource ID determination circuitry 940 may be configured to determine or specify other parameters such as the starting PRB, a flag or indication of whether intra-slot frequency hopping is enabled or disabled, the second hop PRB (in the case of frequency hopping being enbibed), and the DL-Data-to-ULACK indication (whether in sub-slots or at a higher granularity of each symbol). In other aspects, the resource ID determination circuitry 940 may further be configured to execute resource ID determination instructions 950 stored in the computer-readable storage medium 906 to implement any of the one or more of the functions described herein, particularly in relation to the functionalities described in connection with FIGS. 5-8 herein.

In further aspects, it is noted that resource ID determination circuitry 940 may be configured as a means for determining at least one slot format indicator (ID) that correlates to at least one slot format configuration utilized by the wireless communication network. For example, the resource ID determination circuitry 940 may determine the slot format configuration ID (e.g., Format 33) that is mapped to the resource ID for UL resources and the particular parameters therein such as the PUCCH Resource ID and the dlDataToUL-ACK. In other aspects, such means may be implemented with inclusion of other processing circuitries to implement the functionality.

The processor 904 may also include a scheduler circuitry 942 configured to schedule, correlate, and/or map the various determined resource IDs as determined by circuitry 940 with the slot format configurations. In an example, the scheduler circuitry 942 may be configured to keep track of the resource IDs correlated to the respective various slot formats. It is noted that, in an example, the scheduler circuitry 942 may implement RRC or MAC level functionalities. In another example, scheduler circuitry 942 may further be configured to execute scheduler instructions 952 stored in the computer-readable storage medium 906 to implement any of the one or more of the functions described herein.

In further aspects, it is noted that scheduler circuitry 942 may be configured as a means for means for mapping the at least one slot format ID to a respective uplink channel resource identifier (ID), wherein the mapping correlates the at least one slot format ID with the uplink channel resource ID to identify at least one particular sub-slot or symbol in a slot usable for uplink (UL) transmissions on the uplink channel.

The processor 904 may further include communication circuitry 944 configured to utilize a communication link and to communicate with a user equipment (UE) using access communication, and may include RRC signaling or dedicated grant (DG) signaling for configuring a UE to be informed of the UL resource IDs (e.g., n1 PUCCH-AN). The communication circuitry 944 may further be configured to execute communication instructions 954 stored in the computer-readable storage medium 906 to implement any of the one or more of the functions described herein. Additionally, the transmitting circuitry 944 may be configured to transmit, via transceiver 910. RRC messaging or a DG to the UE concerning the UL channel resource ID (e.g., n1PUCCH-AN).

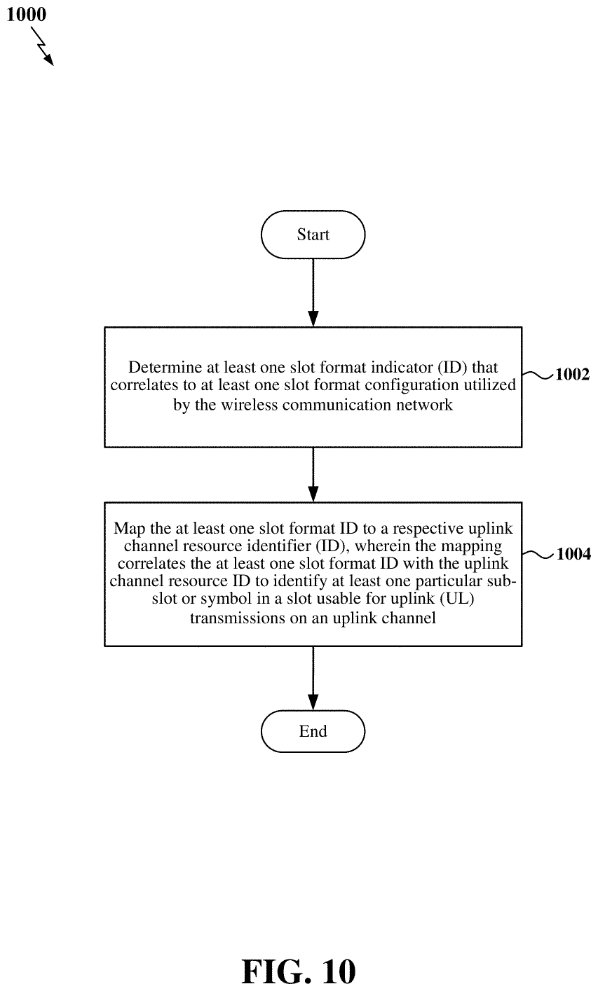

FIG. 10 is a flow chart of a method 1000 for wireless communication at a node, such as a gNB or base station, according to some aspects. In some examples, the method 1000 may be performed by the UE 900, as described above and illustrated in FIG. 9, by a processor or processing system, or by any suitable means for carrying out the described functions.

As shown in FIG. 10, method 1000 includes determining at least one slot format indicator (ID) that correlates to at least one slot format configuration utilized by the wireless communication network as shown at block 1002. In particular examples, the at least one slot format ID may include the slot formatting as discussed above such as the slot format identifications specified in the 3GPP specifications, such as Slot Format 33 and Slot Format 42.

Further, method 1000 includes mapping or correlating the at least one slot format ID to a respective uplink channel resource identifier (ID), wherein the mapping correlates the at least one slot format ID with the uplink channel resource ID to identify at least one particular sub-slot or symbol in a slot usable for uplink (UL) transmissions on the uplink channel as shown in block 1004. In a particular example, it is noted that the processes in block 1004 may include the mapping or correlation of PDCCH Resource ID and dlDataToUL-SCK for a particular slot format configuration as discussed earlier.

According to further aspects, method 1000 may include communicating the mapping of the at least one slot format ID to the respective uplink channel resource ID to a user equipment (UE) in the network, such as through RRC signaling or a DG. Further, the uplink channel may be a physical uplink control channel (PUCCH), where the PUCCH is reserved for a feedback signal received from a user equipment. In further aspects, the feedback signal is a semi-persistent scheduled (SPS) signal. In yet another particular example, method 1000 may include sending a hybrid automatic repeat request (HARQ) to a UE, where the feedback signal is an acknowledgement/non-acknowledgement (ACK/NACK) signal responsive to the HARQ.

In yet other examples, the mapping of the at least one slot format ID to the respective uplink channel resource identifier (ID) is configured to enable a UE to identify the at least one particular symbol in the slot usable for transmissions on the uplink channel. Additionally, in some examples the system is operable according to a dynamic time division duplex (TDD) configuration wherein multiple slot format configurations may be utilized in the system.

According to yet further aspects, method 1000 may include specifying one of a sub-slot or a symbol location in the uplink channel resource ID for the UL channel resource correlating to the one slot format ID. In still other examples, method 1000 may include specifying one or more of an intra-slot frequency hopping enable/disable, a starting physical resource block (PRB) number, or a second hopping PRB number within or associated with the uplink channel resource ID.

In accordance with the example of FIG. 8 discussed above, it is noted that method 1000 may also include mapping the at least one slot format ID to a plurality of respective uplink channel resource identifiers (IDs), wherein the mapping correlates the at least one slot format ID with the uplink channel resource IDs to identify respective particular sub-slots or symbols in a slot usable for uplink (UL) transmissions on the uplink channels. Additionally, each of the plurality of uplink channel resource identifiers (IDs) correspond to a respective semi-persistent scheduled downlink and uplink feedback transmission.

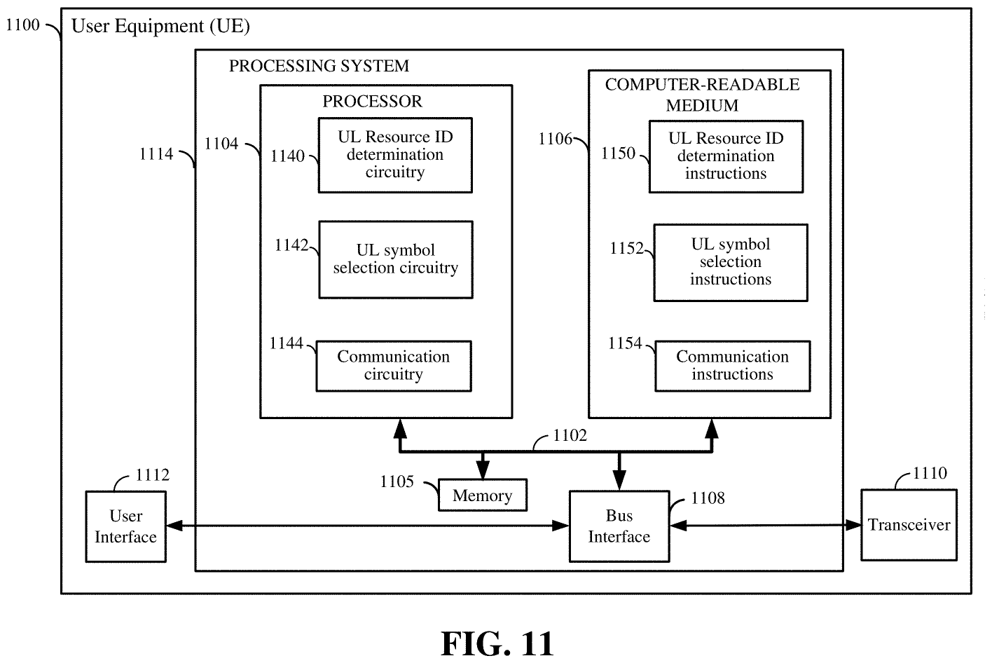

FIG. 11 is a block diagram illustrating an example of a hardware implementation for a wireless communication device or UE 1100 employing a processing system 1114 according to some aspects. For example, the wireless communication device 1100 may correspond to any of the UEs shown and described above in any one or more of FIG. 1, 2, or 4 discussed earlier.

In accordance with various aspects of the disclosure, an element, or any portion of an element, or any combination of elements may be implemented with a processing system 1114 that includes one or more processors 1104. The processing system 1114 may be substantially the same as the processing system 914 illustrated in FIG. 9, including a bus interface 1108, a bus 1102, a processor 1104, and a computer-readable storage medium 1106. Furthermore, the UE 1100 may include a user interface 1112 and a transceiver 1110 substantially similar to those described above in FIG. 9. That is, the processor 1104, as utilized in a UE 1100, may be used to implement any one or more of the processes described herein.

In some aspects of the disclosure, the processor 1104 may include a UL resource ID determination circuitry 1140. In an aspect. UL resource ID determination circuitry 1140 may look up and/or correlate a current slot format configuration (e.g., a current slot format ID) utilized by the wireless communication network to a predetermined UL resource ID (e.g., n1 PUCCH-AN including PUCCH Resource ID and the dlDataToUL-ACK). For example, the resource ID determination circuitry 1140 may determine that the slot format configuration ID (e.g., Format 33) correlates to or is mapped to the UL resource ID. In other aspects, UL resource ID determination circuitry 1140 may further be configured to execute UL resource ID determination instructions 1150 stored in the computer-readable storage medium 1106 to implement any of the one or more of the functions described herein, particularly in relation to the functionalities described in connection with FIGS. 5-8 herein.

In further aspects, it is noted that UL resource ID determination circuitry 1140 may be configured as a means for determining at least one particular sub-slot or symbol in a slot usable by the UE for uplink (UL) transmissions on an uplink (UL) channel based on an uplink channel resource identifier (ID), wherein the uplink channel resource ID correlates to at least one slot format ID associated with a slot format configuration with the uplink channel resource ID. In other aspects, such means may be implemented with inclusion of other processing circuitries to implement the functionality.

In some further aspects of the disclosure, the processor 1104 may include a UL symbol selection circuitry 1142. In an aspect, UL symbol selection circuitry 1142 is configured to determine the symbol or sub-slot that correlates to the UL channel resource ID, which allows the UE to transmit on the UL channel (e.g., PUCCH) without conflict (i.e., in UL symbols in the slot format configuration). In other aspects, UL symbol selection circuitry 1142 may further be configured to execute UL resource ID determination instructions 1152 stored in the computer-readable storage medium 1106 to implement any of the one or more of the functions described herein, particularly in relation to the functionalities described in connection with FIGS. 5-8 herein.

In further aspects, it is noted that UL resource ID determination circuitry 1140 and/or UL symbol selection circuitry 1142 may be configured as a means for determining at least one particular sub-slot or symbol in a slot usable by the UE for uplink (UL) transmissions on an uplink (UL) channel based on an uplink channel resource identifier (ID), wherein the uplink channel resource ID correlates to at least one slot format ID associated with a slot format configuration with the uplink channel resource ID. In other aspects, such means may be implemented with inclusion of other processing circuitries to implement the functionality.

In yet further aspects, processor 1104 may include a communication circuitry 1144 that is configured to transmit on the UL channel to the network. In particular, communication circuitry 1144 may cause the transceiver 1110 to transmit in the particular UL symbol that is selected by UL symbol selection circuitry 1142. In further aspects, the communication circuitry 1144 may further be configured to execute communication instructions 1154 stored in the computer-readable storage medium 1106 to implement any of the one or more of the functions described herein, particularly in relation to the functionalities described in connection with FIGS. 5-8 herein.

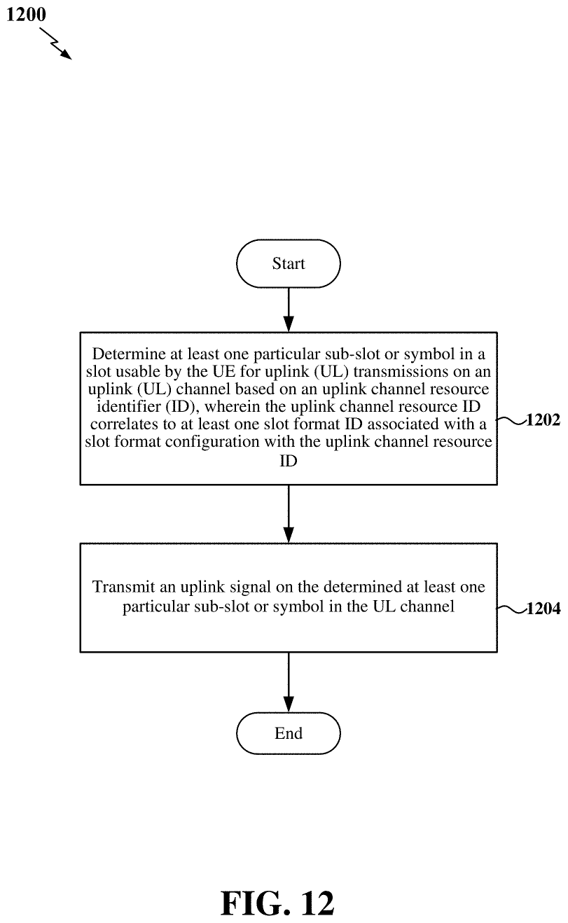

FIG. 12 is a flow chart of a method 1200 for wireless communication in a user equipment (UE) in a wireless communication network, according to some aspects. In some examples, the method 1200 may be performed by the UE 1100, as described above and illustrated in FIG. 11, by a processor or processing system, or by any suitable means for carrying out the described functions.

At block 1202, method 1200 includes determining at least one particular sub-slot or symbol in a slot usable by the UE for uplink (UL) transmissions on an uplink (UL) channel based on an uplink channel resource identifier (ID), wherein the uplink channel resource ID correlates at least one slot format ID associated with a slot format configuration with the uplink channel resource ID. In a particular aspect, the UE is configured to determine which UL resource ID will be utilized based on the current slot format ID, which then allows the UE to determine or look up the correlation between the slot format ID and the UL resource ID. From the determined UL resource ID, the UE may then determine the UL symbol or mini-slot (or sub-slot) that may be used on the UL channel (e.g., PUCCH) for transmission by the UE, such as for transmission of a feedback signal (e.g., ACK/NACK). Once the determination is made of the UL symbol (or mini-slot or sub-slot), the uplink signal may then be transmitted by the UE to the base station or network node on the determined at least one particular sub-slot or symbol in the UL channel as shown in block 1204.

In further aspects, method 1200 may include receiving the correlation of the at least one slot format ID to the respective uplink channel resource ID from a base station in the network, such as via RRC signaling or DG communication. Additionally, the uplink channel is a physical uplink control channel (PUCCH), the UL signal is a feedback signal transmitted to a base station in the network, which may further be configured as a semi-persistent scheduled (SPS) signal. In yet further aspects, method 1200 may include receiving a hybrid automatic repeat request (HARQ) from the base station, and the feedback signal is an acknowledgement/non-acknowledgement (ACK/NACK) signal sent to the base station responsive to the HARQ.

In yet further aspects, the network is operating with a dynamic time division duplex (TDD) configuration where multiple slot format configurations may be utilized in the system as discussed above. Also, the uplink channel resource ID includes one or more of intra-slot frequency hopping enable/disable, a starting physical resource block (PRB) number, or a second hopping PRB number as discussed above.

According to further aspect, method 1200 may include determining respective particular sub-slots or symbols in a slot usable for a plurality of uplink (UL) transmissions on the uplink channel based on a plurality of uplink channel resource IDs, such as was discussed in connection with the example of FIG. 8. Moreover, each of the plurality of uplink channel resource IDs correspond to a respective semi-persistent scheduled downlink and uplink feedback transmission.

Several aspects of a wireless communication network have been presented with reference to one or more exemplary implementations. As those skilled in the art will readily appreciate, various aspects described throughout this disclosure may be extended to other telecommunication systems, network architectures and communication standards.

The following provides an overview of aspects of the present disclosure:

Aspect 1: A method for wireless communication at a network node in a wireless communication network, comprising: determining at least one slot format indicator (ID) that correlates to at least one slot format configuration utilized by the wireless communication network; and mapping the at least one slot format ID to a respective uplink (UL) channel resource identifier (ID), wherein the mapping correlates the at least one slot format ID with the UL channel resource ID to identify at least one particular sub-slot or symbol in a slot usable for uplink (UL) transmissions on an uplink channel.

Aspect 2: The method of aspect 1, further comprising: communicating the mapping of the at least one slot format ID to the respective uplink channel resource ID to a user equipment (UE) in the network.

Aspect 3: The method of aspect 1 or aspect 2, wherein the uplink channel comprises a physical uplink control channel (PUCCH).

Aspect 4: The method of aspect 3, wherein the PUCCH is reserved for a feedback signal received from a UE.

Aspect 5: The method of aspect 4, wherein the feedback signal comprises a semi-persistent scheduled (SPS) signal.

Aspect 6: The method of any of aspects 1 through 5, further comprising: sending a hybrid automatic repeat request (HARQ) to a UE; and wherein the feedback signal is an acknowledgement/non-acknowledgement (ACK/NACK) signal responsive to the HARQ.

Aspect 7: The method of any of aspects 1 through 6, wherein the mapping of the at least one slot format ID to the respective uplink channel resource identifier (ID) is configured to enable a UE to identify the at least one particular symbol in the slot usable for transmissions on the uplink channel.

Aspect 8: The method of any of aspects 1 through 7, wherein the wireless communication network is operable with a dynamic time division duplex (TDD) configuration wherein multiple slot format configurations may be utilized in the wireless communication network.

Aspect 9: The method of any of aspects 1 through 8, further comprising: specifying one of a sub-slot or a symbol location in the uplink channel resource ID for the uplink channel resource correlating to the at least one slot format ID.

Aspect 10: The method of any of aspects 1 through 9, further comprising: specifying one or more of intra-slot frequency hopping enable/disable, a starting physical resource block (PRB) number, or a second hopping PRB number in the uplink channel resource ID.

Aspect 11: The method of any of aspects 1 through 10, further comprising: mapping the at least one slot format ID to a plurality of respective uplink channel resource identifiers (IDs), wherein the mapping correlates the at least one slot format ID with the uplink channel resource IDs to identify respective particular sub-slots or symbols in a slot usable for uplink transmissions on a plurality of uplink channels.

Aspect 12: The method of aspect 11, wherein each of the plurality of uplink channel resource identifiers (IDs) correspond to a respective semi-persistent scheduled downlink and uplink feedback transmission.

Aspect 13: A network node in a wireless communication system, comprising: a wireless transceiver; a memory; and a processor communicatively coupled to the wireless transceiver and the memory, wherein the processor and the memory are configured to: determine at least one slot format indicator (ID) that correlates to at least one slot format configuration utilized by the wireless communication system; and map the at least one slot format ID to a respective uplink (UL) channel resource identifier (ID), wherein the mapping correlates the at least one slot format ID with the uplink channel resource ID to identify at least one particular sub-slot or symbol in a slot usable for uplink (UL) transmissions on an uplink channel.

Aspect 14: The network node of aspect 13, wherein the processor and the memory are configured to: communicate the mapping of the at least one slot format ID to the respective uplink channel resource ID to a user equipment (UE) in the network.

Aspect 15: The network node of aspects 13 or 14, wherein the uplink channel comprises a physical uplink control channel (PUCCH).

Aspect 16: The network node of aspect 15, wherein the PUCCH is reserved for a feedback signal received from a UE.

Aspect 17: The network node of aspect 16, wherein the feedback signal comprises a semi-persistent scheduled (SPS) signal.

Aspect 18: The network node of any of aspects 13 through 17, wherein the mapping of the at least one slot format ID to the respective uplink channel resource identifier (ID) is configured to enable a UE to identify the at least one particular symbol in the slot usable for transmissions on the uplink channel.

Aspect 19: The network node of any of aspects 13 through 18, wherein the wireless communication system is operable with a dynamic time division duplex (TDD) configuration wherein multiple slot format configurations may be utilized in the wireless communication system.

Aspect 20: The network node of any of aspects 13 through 19, wherein the processor and the memory are configured to specify one of a sub-slot or a symbol location in the uplink channel resource ID for the uplink channel resource correlating to the at least one slot format ID.

Aspect 21: The network node of any of aspects 13 through 20, wherein the processor and the memory are configured to specify one or more of intra-slot frequency hopping enable/disable, a starting physical resource block (PRB) number, or a second hopping PRB number in the uplink channel resource ID.

Aspect 22: The network node of any of aspects 13 through 21, wherein the processor and the memory are configured to map the at least one slot format ID to a plurality of respective uplink channel resource identifiers (IDs), wherein the mapping correlates the at least one slot format ID with the uplink channel resource IDs to identify respective particular sub-slots or symbols in a slot usable for uplink (UL) transmissions on a plurality of uplink channels.

Aspect 23: The network node of aspect 22, wherein each of the plurality of uplink channel resource identifiers (IDs) correspond to a respective semi-persistent scheduled downlink and uplink feedback transmission.

Aspect 24: A method for wireless communication in a user equipment (UE) in a wireless communication network, comprising: determining at least one particular sub-slot or symbol in a slot usable by the UE for uplink (UL) transmissions on an uplink (UL) channel based on an uplink channel resource identifier (ID), wherein the uplink channel resource ID correlates at least one slot format ID associated with a slot format configuration with the uplink channel resource ID; and transmitting an uplink (UL) signal on the determined at least one particular sub-slot or symbol in the UL channel.

Aspect 25: The method of aspect 24, wherein the uplink channel comprises a physical uplink control channel (PUCCH).

Aspect 26: The method of aspect 24 or aspect 25, wherein the UL signal comprises a semi-persistent scheduled (SPS) feedback signal transmitted to a base station in the wireless communication network.

Aspect 27: The method of any one of aspects 24 through 26, wherein the wireless communication network is operable according to a dynamic time division duplex (TDD) configuration wherein multiple slot format configurations may be utilized in the wireless communication network.

Aspect 28: The method of any one of aspects 24 through 27, wherein the uplink channel resource ID includes one or more of intra-slot frequency hopping enable/disable, a starting physical resource block (PRB) number, or a second hopping PRB number.

Aspect 29: The method of any one of aspects 24 through 28, further comprising: determining respective particular sub-slots or symbols in a slot usable for a plurality of uplink (UL) transmissions on the uplink channel based on a plurality of uplink channel resource IDs; wherein each of the plurality of uplink channel resource IDs correspond to a respective semi-persistent scheduled downlink and uplink feedback transmission.

Aspect 30: A user equipment (UE) operable in a wireless communication system, comprising: a wireless transceiver; a memory; and a processor communicatively coupled to the wireless transceiver and the memory, wherein the processor and the memory are configured to: determine at least one particular sub-slot or symbol in a slot usable by the UE for uplink (UL) transmissions on an uplink (UL) channel based on an uplink channel resource identifier (ID), wherein the uplink channel resource ID is correlated to at least one slot format ID associated with a slot format configuration with the uplink channel resource ID; and transmit an uplink signal on the determined at least one particular sub-slot or symbol in the UL channel.

Aspect 31: An apparatus configured for wireless communication comprising at least one means for performing a method of any one of aspects 1 through 12 or aspects 24 through 29.

Aspect 32: A non-transitory computer-readable medium storing computer-executable code, comprising code for causing an apparatus to perform a method of any one of aspects 1 through 12 or aspects 24 through 29.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20. Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature, or function or embodied in several components, steps, or functions. Additional stages, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present stages of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an stage in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the stages of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication at a network node in a wireless communication network, comprising:
determining at least one slot format indicator (ID) that correlates to at least one slot format configuration utilized by the wireless communication network; and
mapping the at least one slot format ID to a respective uplink (UL) channel resource identifier (ID), wherein the mapping correlates the at least one slot format ID with the UL channel resource ID to identify at least one particular sub-slot or symbol in a slot usable for uplink (UL) transmissions on an uplink channel.

2. The method of claim 1, further comprising:
communicating the mapping of the at least one slot format ID to the respective uplink channel resource ID to a user equipment (UE) in the network.

3. The method of claim 1, wherein the uplink channel comprises a physical uplink control channel (PUCCH).

4. The method of claim 3, wherein the PUCCH is reserved for a feedback signal received from a UE.

5. The method of claim 4, wherein the feedback signal comprises a semi-persistent scheduled (SPS) signal.

6. The method of claim 4, further comprising:
sending a hybrid automatic repeat request (HARQ) to a UE; and
wherein the feedback signal is an acknowledgement/non-acknowledgement (ACK/NACK) signal responsive to the HARQ.

7. The method of claim 1, wherein the mapping of the at least one slot format ID to the respective uplink channel resource identifier (ID) is configured to enable a UE to identify the at least one particular symbol in the slot usable for transmissions on the uplink channel.

8. The method of claim 1, wherein the wireless communication network is operable with a dynamic time division duplex (TDD) configuration wherein multiple slot format configurations may be utilized in the wireless communication network.

9. The method of claim 1, further comprising:
specifying one of a sub-slot or a symbol location in the uplink channel resource ID for the uplink channel resource correlating to the at least one slot format ID.

10. The method of claim 1, further comprising:
specifying one or more of intra-slot frequency hopping enable/disable, a starting physical resource block (PRB) number, or a second hopping PRB number in the uplink channel resource ID.

11. The method of claim 1, further comprising:
mapping the at least one slot format ID to a plurality of respective uplink channel resource identifiers (IDs), wherein the mapping correlates the at least one slot format ID with the uplink channel resource IDs to identify respective particular sub-slots or symbols in a slot usable for uplink transmissions on a plurality of uplink channels.

12. The method of claim 11, wherein each of the plurality of uplink channel resource identifiers (IDs) correspond to a respective semi-persistent scheduled downlink and uplink feedback transmission.

13. A network node in a wireless communication system, comprising:
a wireless transceiver;
a memory; and
a processor communicatively coupled to the wireless transceiver and the memory, wherein the processor and the memory are configured to:
determine at least one slot format indicator (ID) that correlates to at least one slot format configuration utilized by the wireless communication system; and
map the at least one slot format ID to a respective uplink (UL) channel resource identifier (ID), wherein the mapping correlates the at least one slot format ID with the uplink channel resource ID to identify at least one particular sub-slot or symbol in a slot usable for uplink (UL) transmissions on an uplink channel.

14. The network node of claim 13, wherein the processor and the memory are configured to:
communicate the mapping of the at least one slot format ID to the respective uplink channel resource ID to a user equipment (UE) in the network.

15. The network node of claim 13, wherein the uplink channel comprises a physical uplink control channel (PUCCH).

16. The network node of claim 15, wherein the PUCCH is reserved for a feedback signal received from a UE.

17. The network node of claim 16, wherein the feedback signal comprises a semi-persistent scheduled (SPS) signal.

18. The network node of claim 13, wherein the mapping of the at least one slot format ID to the respective uplink channel resource identifier (ID) is configured to enable a UE to identify the at least one particular symbol in the slot usable for transmissions on the uplink channel.

19. The network node of claim 13, wherein the wireless communication system is operable with a dynamic time division duplex (TDD) configuration wherein multiple slot format configurations may be utilized in the wireless communication system.

20. The network node of claim 13, wherein the processor and the memory are configured to specify one of a sub-slot or a symbol location in the uplink channel resource ID for the uplink channel resource correlating to the at least one slot format ID.

21. The network node of claim 13, wherein the processor and the memory are configured to specify one or more of intra-slot frequency hopping enable/disable, a starting physical resource block (PRB) number, or a second hopping PRB number in the uplink channel resource ID.

22. The network node of claim 13, wherein the processor and the memory are configured to map the at least one slot format ID to a plurality of respective uplink channel resource identifiers (IDs), wherein the mapping correlates the at least one slot format ID with the uplink channel resource IDs to identify respective particular sub-slots or symbols in a slot usable for uplink (UL) transmissions on a plurality of uplink channels.

23. The network node of claim 22, wherein each of the plurality of uplink channel resource identifiers (IDs) correspond to a respective semi-persistent scheduled downlink and uplink feedback transmission.

24. A method for wireless communication in a user equipment (UE) in a wireless communication network, comprising:
determining at least one particular sub-slot or symbol in a slot usable by the UE for uplink (UL) transmissions on an uplink (UL) channel based on an uplink channel resource identifier (ID), wherein the uplink channel resource ID correlates at least one slot format ID associated with a slot format configuration with the uplink channel resource ID; and
transmitting an uplink (UL) signal on the determined at least one particular sub-slot or symbol in the UL channel.

25. The method of claim 24, wherein the uplink channel comprises a physical uplink control channel (PUCCH).

26. The method of claim 24, wherein the UL signal comprises a semi-persistent scheduled (SPS) feedback signal transmitted to a base station in the wireless communication network.

27. The method of claim 24, wherein the wireless communication network is operable according to a dynamic time division duplex (TDD) configuration wherein multiple slot format configurations may be utilized in the wireless communication network.

28. The method of claim 24, wherein the uplink channel resource ID includes one or more of intra-slot frequency hopping enable/disable, a starting physical resource block (PRB) number, or a second hopping PRB number.

29. The method of claim 24, further comprising:
determining respective particular sub-slots or symbols in a slot usable for a plurality of uplink (UL) transmissions on the uplink channel based on a plurality of uplink channel resource IDs;
wherein each of the plurality of uplink channel resource IDs correspond to a respective semi-persistent scheduled downlink and uplink feedback transmission.

30. A user equipment (UE) operable in a wireless communication system, comprising:
a wireless transceiver;
a memory; and
a processor communicatively coupled to the wireless transceiver and the memory, wherein the processor and the memory are configured to:
determine at least one particular sub-slot or symbol in a slot usable by the UE for uplink (UL) transmissions on an uplink (UL) channel based on an uplink channel resource identifier (ID), wherein the uplink channel resource ID is correlated to at least one slot format ID associated with a slot format configuration with the uplink channel resource ID; and
transmit an uplink signal on the determined at least one particular sub-slot or symbol in the UL channel.
